(19) United States
(12) Patent Application Publication
(10) Pub. No.: US 2019/0377137 A1
(43) Pub. Date: Dec. 12, 2019

(54) METHOD FOR MANUFACTURING OPTICAL CONNECTOR FERRULE, OPTICAL CONNECTOR FERRULE, AND OPTICAL FIBER WITH CONNECTOR

(71) Applicant: SUMITOMO ELECTRIC INDUSTRIES, LTD., Osaka-shi, Osaka (JP)

(72) Inventors: Fumiya UEHARA, Yokohama-shi, Kanagawa (JP); Masaki OHMURA, Yokohama-shi, Kanagawa (JP); Tomomi SANO, Yokohama-shi, Kanagawa (JP)

(73) Assignee: SUMITOMO ELECTRIC INDUSTRIES, LTD., Osaka-shi, Osaka (JP)

(21) Appl. No.: 16/485,251

(22) PCT Filed: Dec. 19, 2017
(86) PCT No.: PCT/JP2017/045537

§ 371 Date: Aug. 12, 2019

(30) Foreign Application Priority Data
Mar. 13, 2017 (JP) 2017-047398

(51) Int. Cl. G02B 6/38; B29C 45/26; B29D 11/00; B29C 45/36; G02B 6/36

(52) U.S. Cl. CPC G02B 6/381; B29C 45/2628; G02B 6/3696; B29C 45/36; B29D 11/0075

(57) ABSTRACT

A method of manufacturing an optical connector ferrule includes a step of forming the optical connector ferrule by introducing a resin into a die. The optical connector ferrule includes one end surface and the other end surface, a pair of side surfaces, a front surface and a back surface, an introduction port that introduces a plurality of optical fibers in a bundle, a plurality of optical fiber holding holes that penetrate from the introduction port to the one end surface and hold the plurality of optical fibers, respectively, and a window hole that penetrates from the surface to the introduction port. A distance between a center of a gate and the front surface is less than a distance between the center of the gate and the back surface.

### TECHNICAL FIELD

The present disclosure relates to a method of manufacturing an optical connector ferrule, an optical connector ferrule, and an optical fiber with a connector. This application is based upon and claims the benefit of priority from Japanese Patent Application No. 2017-047398, filed on Mar. 13, 2017, the entire content of which is incorporated herein by reference.

### BACKGROUND ART

Patent Literature 1 discloses techniques associated with an optical ferrule and an optical connector. The optical ferrule described in Patent Literature 1 includes an insertion opening which is an insertion port of optical fibers, optical fiber insertion holes that are open on a connector connecting end surface and which optical fibers are inserted into and positioned at, and a recessed portion in which a gate for resin molding is disposed. Patent Literature 2 discloses techniques associated with a die for molding a ferrule and a ferrule for an optical connector. The die for molding a ferrule described in Patent Literature 2 includes a pair of dies that are closed to form a cavity and a plurality of array hole forming pins that form fiber array holes. The pair of dies form a gate serving as a filling port of a molten resin into the cavity when they are closed.

### CITATION LIST

### Patent Literature

Patent Literature 1: Japanese Unexamined Patent Publication No. 2001-4872

Patent Literature 2: Japanese Unexamined Patent Publication No. 2000-289058

### SUMMARY OF INVENTION

A method of manufacturing an optical connector ferrule according to the present disclosure is a method of manufacturing an optical connector ferrule formed of a resin, including a step of forming the optical connector ferrule by introducing the resin into a cavity of a die which includes the cavity corresponding to a shape of the optical connector ferrule and curing the resin. The optical connector ferrule includes one end surface and another end surface that are opposite to each other in a first direction, a pair of side surfaces that are opposite to each other in a second direction which crosses the first direction, a front surface and a back surface that are opposite to each other in a third direction which crosses the first direction and the second direction, an introduction port that is formed on the other end surface and introduces a plurality of optical fibers in the first direction in a bundle, a plurality of optical fiber holding holes that penetrate from the introduction port to the one end surface and hold each of the plurality of optical fibers, and a window hole that penetrates from the front surface to the introduction port. A gate of the die is disposed on the pair of side surfaces which are located on the other end surface side with respect to the window hole in the first direction. A distance between a center of the gate and the front surface in the third direction is less than a distance between the center of the gate and the back surface in the third direction.

An optical connector ferrule according to an embodiment is an optical connector ferrule formed of a resin, including one end surface and another end surface that are opposite to each other in a first direction, a pair of side surfaces that are opposite to each other in a second direction which crosses the first direction, a front surface and a back surface that are opposite to each other in a third direction which crosses the first direction and the second direction, an introduction port that is formed on the other end surface and introduces a plurality of optical fibers in the first direction in a bundle, a plurality of optical fiber holding holes that penetrate from the introduction port to the one end surface and hold each of the plurality of optical fibers, a window hole that penetrates from the front surface to the introduction port, and a gate mark that is formed at the time of injection molding. The gate mark is formed on the pair of side surfaces which are located on the other end surface side with respect to the window hole in the first direction. A distance between a center of the gate mark and the front surface in the third direction is less than a distance between the center of the gate mark and the back surface in the third direction.

### BRIEF DESCRIPTION OF DRAWINGS

FIG. 1 is a perspective view illustrating an appearance of an optical connector ferrule which is manufactured using a manufacturing method according to an embodiment.

FIG. 2 is a sectional view illustrating a section of the optical connector ferrule taken along line II-II.

FIG. 3 is a perspective view illustrating an appearance of an optical fiber with a connector including the optical connector ferrule.

FIG. 4 is a side view of the optical connector ferrule.

FIG. 5 is an exploded perspective view of a die for molding an optical connector ferrule which is used to mold the optical connector ferrule.

FIG. 6 is a sectional view of a molding die and illustrates a lateral section taken along an XZ plane.

FIG. 7 is a perspective view illustrating an internal structure of the molding die (a middle die).

FIG. 8 is an enlarged perspective view of a protruding portion.

FIG. 9 is a diagram illustrating a simulation result of a flow of a molten resin when a gate of a die is disposed at an equal distance from a front surface and a back surface.

FIG. 10 is a diagram illustrating a simulation result of a flow of a molten resin when a gate of a die is disposed at an equal distance from a front surface and a back surface.

FIG. 11 is a diagram illustrating a simulation result of a flow of a molten resin when a gate of a die is disposed at an equal distance from a front surface and a back surface.

FIG. 12 is a diagram illustrating a flow analysis result in association with an injection pressure and illustrating an analysis result when seen from a side surface side in a case in which a gate center position is close to the front surface.

FIG. 13 is a diagram illustrating a flow analysis result in association with an injection pressure and illustrating an analysis result when seen from the front surface side in a case in which the gate center position is close to the front surface.

FIG. 14 is a diagram illustrating a flow analysis result in association with an injection pressure and illustrating an analysis result when seen from the side surface side in a case in which the gate center position is disposed at an equal distance from the front surface and the back surface.

FIG. 15 is a diagram illustrating a flow analysis result in association with an injection pressure and illustrating an analysis result when seen from the front surface side in a case in which the gate center position is disposed at an equal distance from the front surface and the back surface.

FIG. 16 is a diagram illustrating a flow analysis result in association with an injection pressure and illustrating an analysis result when seen from the side surface side in a case in which the gate center position is close to the back surface.

FIG. 17 is a diagram illustrating a flow analysis result in association with an injection pressure and illustrating an analysis result when seen from the front surface side in a case in which the gate center position is close to the back surface.

FIG. 18 is a graph illustrating an example of a relationship between a vertical position of the gate center position and an inclination angle of a center axis direction of an optical fiber holding hole on a front end surface with respect to a first direction.

FIG. 19 is a diagram illustrating a flow analysis result in association with an injection pressure when the number of optical fiber holding holes per stage is set to 12 and illustrating an analysis result when seen from the side surface side in a case in which the gate center position is close to the front surface.

FIG. 20 is a diagram illustrating a flow analysis result in association with an injection pressure when the number of optical fiber holding holes per stage is set to 12 and illustrating an analysis result when seen from the front surface side in a case in which the gate center position is close to the front surface. FIG. 21 is a diagram illustrating a flow analysis result in association with an injection pressure when the number of optical fiber holding holes per stage is set to 12 and illustrating an analysis result when seen from the side surface in a case in which the gate center position is disposed at an equal distance from the front surface and the back surface.

FIG. 22 is a diagram illustrating a flow analysis result in association with an injection pressure when the number of optical fiber holding holes per stage is set to 12 and illustrating an analysis result when seen from the front surface in a case in which the gate center position is disposed at an equal distance from the front surface and the back surface.

FIG. 23 is a diagram illustrating a flow analysis result in association with an injection pressure when the number of optical fiber holding holes per stage is set to 12 and illustrating an analysis result when seen from the side surface side in a case in which the gate center position is close to the back surface.

FIG. 24 is a diagram illustrating a flow analysis result in association with an injection pressure when the number of optical fiber holding holes per stage is set to 12 and illustrating an analysis result when seen from the front surface side in a case in which the gate center position is close to the back surface.

FIG. 25 is a sectional view illustrating a state in which an optical fiber holding hole is inclined.

### DESCRIPTION OF EMBODIMENTS

[Problem to be Solved by Present Disclosure]

There are several optical coupling methods for optical coupling between an optical fiber and another optical component. Examples of another optical component include an optical fiber and a light emitting element. One example of the optical coupling method is a coupling method using an optical connector ferrule such as a mechanically transferable (MT) connector ferrule. For example, as described in Patent Literatures 1 and 2, an optical connector ferrule is formed by filling a cavity formed by a die with a molten resin, curing the molten resin, and taking the cured resin out of the die. A plurality of optical fiber hole forming pins are provided in the cavity.

The optical fiber hole foaming pins are used to form optical fiber holding holes (optical fiber insertion holes) in the optical connector ferrule.

When a flow of the molten resin is disturbed in molding of such an optical connector ferrule, an injection pressure in the cavity becomes irregular. When a plurality of optical fiber hole forming pins are arranged in the cavity of the die, a center axis direction of the optical fiber holding holes may be inclined. This inclination is caused by inclination of the optical fiber hole forming pins, an internal stress at the time of curing the molten resin, and the like which are generated due to irregularity in the injection pressure. Particularly, in the MT ferrule, a window hole is provided on a surface. The window hole is used for visual checking and injection of an adhesive at the time of insertion of optical fibers into the optical fiber holding holes. A die for forming the window hole hinders a flow of the molten resin. As a result, the above-mentioned problem is likely to occur.

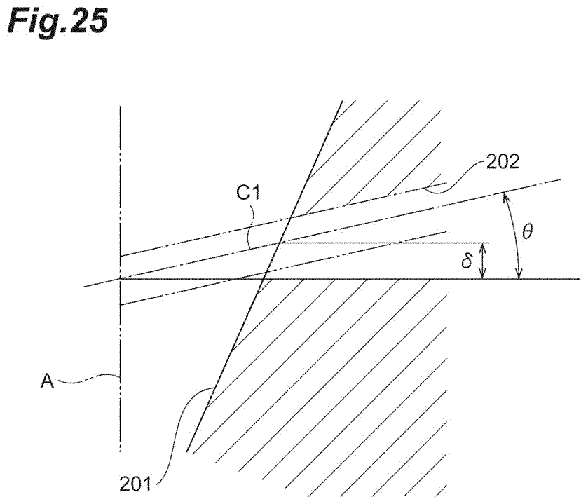

FIG. 25 is a sectional view illustrating a state in which an optical fiber holding hole is inclined. An end surface of an optical connector ferrule is polished after a resin has been cured. For example, an end surface 201 of the optical connector ferrule illustrated in FIG. 25 is polished to be inclined by a predetermined angle in order to decrease reflection of light at the time of connection. An example of the predetermined angle is 8°. A in the drawing indicates an end surface before it is polished. However, when the direction of a center axis C1 of an optical fiber holding hole 202 is inclined (an angle θ) from a predetermined direction (typically a normal direction of the end surface 201 before it is polished), an opening position of the optical fiber holding hole 202 on the end surface 201 is displaced with progress of polishing (δ in the drawing). This displacement of the opening position causes position displacement of a front end face of an optical fiber which is held in the optical fiber holding hole 202. Accordingly, the displacement of the opening position causes an increase in connection loss between optical connectors.

The present disclosure is invented in consideration of the above-mentioned problems. The present disclosure provides a method of manufacturing an optical connector ferrule, an optical connector ferrule, and an optical fiber with a connector that can curb an increase in connection loss.

[Advantageous Effects of Present Disclosure]

With the method of manufacturing an optical connector ferrule, the optical connector ferrule, and the optical fiber with a connector according to the present disclosure, it is possible to curb an increase in connection loss.

[Description of Embodiment of Present Disclosure]

Details of an embodiment of the present disclosure will be first listed and described. A method of manufacturing an optical connector ferrule according to the embodiment is a method of manufacturing an optical connector ferrule formed of a resin, including a step of foaming the optical connector ferrule by introducing the resin into a cavity of a die which includes the cavity corresponding to a shape of the optical connector ferrule and curing the resin. The optical connector ferrule includes one end surface and another end surface that are opposite to each other in a first direction, a pair of side surfaces that are opposite to each other in a second direction which crosses the first direction, a front surface and a back surface that are opposite to each other in a third direction which crosses the first direction and the second direction, an introduction port that is formed on the other end surface and introduces a plurality of optical fibers in the first direction in a bundle, a plurality of optical fiber holding holes that penetrate from the introduction port to the one end surface and hold each of the plurality of optical fibers, and a window hole that penetrates from the front surface to the introduction port. A gate of the die is disposed on the pair of side surfaces which are located on the other end surface side with respect to the window hole in the first direction. A distance between a center of the gate and the front surface in the third direction is less than a distance between the center of the gate and the back surface in the third direction.

An optical connector ferrule according to an embodiment is an optical connector ferrule formed of a resin, including one end surface and the other end surface that are opposite to each other in a first direction, a pair of side surfaces that are opposite to each other in a second direction which crosses the first direction, a front surface and a back surface that are opposite to each other in a third direction which crosses the first direction and the second direction, an introduction port that is formed on the other end surface and introduces a plurality of optical fibers in the first direction in a bundle, a plurality of optical fiber holding holes that penetrate from the introduction port to the one end surface and hold the plurality of optical fibers, respectively, a window hole that penetrates from the surface to the introduction port, and a gate mark that is formed at the time of injection molding. The gate mark is formed on the pair of side surfaces which are located on the other end surface side with respect to the window hole in the first direction. A distance between a center of the gate mark and the surface in the third direction is less than a distance between the center of the gate mark and the back surface in the third direction.

For example, in the method described in Patent Literature 1, a gate of a die which is disposed in a flange portion is disposed at a position separated by an equal distance from the front surface and the back surface. However, in this case, a flow of the molten resin on the front surface side is slowed down due to the die for forming the window hole provided on only the front surface side. As a result, since a flow of the molten resin on the back surface side speeds up relatively, the irregularity in injection pressure may occur. On the other hand, in the manufacturing method and the optical connector ferrule, the gate (or the gate mark) of the die is disposed on a pair of side surfaces which are located close to the other end surface with respect to the window hole in the first direction. The distance between the center of the gate (the gate mark) and the surface in the third direction is less than the distance between the center of the gate (the gate mark) and the back surface in the third direction. In this way, the position of the gate (the gate mark) of the die in the third direction is made to be close to the surface. As a result, since balance between the flows of the molten resin on the front surface side and the back surface side is improved, it is possible to relax the irregularity in injection pressure. Accordingly, it is possible to reduce an inclination in the center axis direction of the optical fiber holding holes and to reduce displacement of the opening positions of the optical fiber holding holes after it is polished. Accordingly, with the manufacturing method and the optical connector ferrule, it is possible to curb an increase in connection loss between the optical connectors. With the optical connector ferrule, whether it is an optical connector ferrule which is manufactured using the method capable of curbing an increase in connection loss can be determined by visually checking that the gate mark is closer to the front surface than the back surface. In other words, with the optical connector ferrule, it is possible to visually check whether it is an optical connector ferrule with high dimensional accuracy.

In the method of manufacturing an optical connector ferrule and the optical connector ferrule, an opening width of the window hole in the second direction on the surface may be in a range of 60% to 90% of a gap between the pair of side surfaces in the second direction. When the opening width in the second direction of the window hole is equal to or greater than 60% of the gap between the side surfaces, the die for forming the window hole increases in thickness and thus the flow of the molten resin is likely to be hindered. Accordingly, the manufacturing method and the optical connector ferrule are particularly effective.

In the method of manufacturing an optical connector ferrule and the optical connector ferrule, an opening width of the window hole in the second direction on the surface may be in a range of 3.9 mm to 6.2 mm, and a distance between a center position of the gate (or the gate mark) and a plane which is separated by an equal distance from the front surface and the back surface in the third direction may be in a range of 0.1 mm to 1.25 mm. For example, when 16 optical fibers are arranged at pitches of 0.25 mm in the second direction, the horizontal width of the optical fiber bundle in the second direction is 3.875 mm. When the opening width of the window hole is equal to or greater than 3.9 mm, the die for forming the window hole increases in thickness and thus the flow of the molten resin is likely to be hindered. Accordingly, the manufacturing method and the optical connector ferrule are particularly effective. Since the distance between the center position of the gate mark and the plane which is disposed at an equal distance from the front surface and the back surface in the third direction is equal to or greater than 0.1 mm, it is possible to enhance visibility when it is checked whether it is an optical connector ferrule which is manufactured using the method of capable of curbing an increase in connection loss. In other words, it is possible to enhance visibility when it is checked whether it is an optical connector ferrule with high dimensional accuracy.

In the method of manufacturing an optical connector ferrule and the optical connector ferrule, at least one optical fiber holding hole array including 16 or more optical fiber holding holes which are arranged in the second direction may be arranged in the third direction. In this case, the opening width of the window hole is increased. As a result, since the die for forming the window hole increases in thickness, the flow of the molten resin is likely to be hindered. Accordingly, the manufacturing method and the optical connector ferrule are particularly effective.

In the method of manufacturing an optical connector ferrule and the optical connector ferrule, a size of the gate (the gate mark) in the first direction may be in a range of 0.5 mm to 1.2 mm and a size of the gate (the gate mark) in the third direction may be in a range of 0.5 mm to 2.5 mm. Since the gate (the gate mark) has a sufficient size, it is possible to easily visually check displacement of the center position of the gate mark in the third direction.

In the method of manufacturing an optical connector ferrule and the optical connector ferrule, the resin may be a polyphenylene sulfide resin. Accordingly, it is possible to realize an optical connector ferrule with high dimensional accuracy and excellent mechanical strength.

The method of manufacturing an optical connector ferrule may further include a step of polishing the one end surface such that an angle which is formed by a center axis of the plurality of optical fiber holding holes and a normal line of the one end surface is in a range of 10° to 20°. Similarly, in the optical connector ferrule, the angle which is formed by the center axis of the plurality of optical fiber holding holes and the normal line of the one end surface is in a range of 10° to 20°.

In this way, when the inclination angle of the one end surface is great, an amount of polishing increases. As a result, when the center axis direction of the optical fiber holding holes is inclined, displacement of the opening position of the optical fiber holding holes after it is polished further increases. Accordingly, the manufacturing method and the optical connector ferrule are particularly effective.

An optical fiber with a connector according to an embodiment includes the above-mentioned optical connector ferrule and a plurality of optical fibers that are introduced from the introduction port and are held in the plurality of optical fiber holding holes, front end faces thereof being exposed from the one end surface. The optical fiber with a connector includes several pieces of the optical connector ferrule. As a result, the optical fiber with a connector can curb an increase in connection loss between the optical connectors.

The method of manufacturing an optical fiber with a connector ferrule according to the embodiment may further include a step of polishing the one end surface such that an angle which is formed by a center axis of the plurality of optical fiber holding holes and a normal line of the one end surface is 8°.

The method of manufacturing an optical fiber with a connector ferrule according to the embodiment may further include a step of polishing the one end surface such that an angle which is formed by a center axis of the plurality of optical fiber holding holes and a nominal line of the one end surface is 0°.

In the optical connector ferrule according to the embodiment, an angle which is formed by a center axis of the plurality of optical fiber holding holes and a normal line of the one end surface may be 8°.

In the optical connector ferrule according to the embodiment, an angle which is formed by a center axis of the plurality of optical fiber holding holes and a normal line of the one end surface may be 0°.

[Details of Embodiment of Present Disclosure]

Specific examples of a method of manufacturing an optical connector ferrule, an optical connector ferrule, an optical fiber with a connector according to the present disclosure will be described below with reference to the accompanying drawings. The present disclosure is not limited to the examples. The present disclosure is defined by the appended claims and is intended to include all modifications within the meaning and scope equivalent to the claims. In the following description, the same elements in the drawings will be referred to by the same reference signs and description thereof will not be repeated.

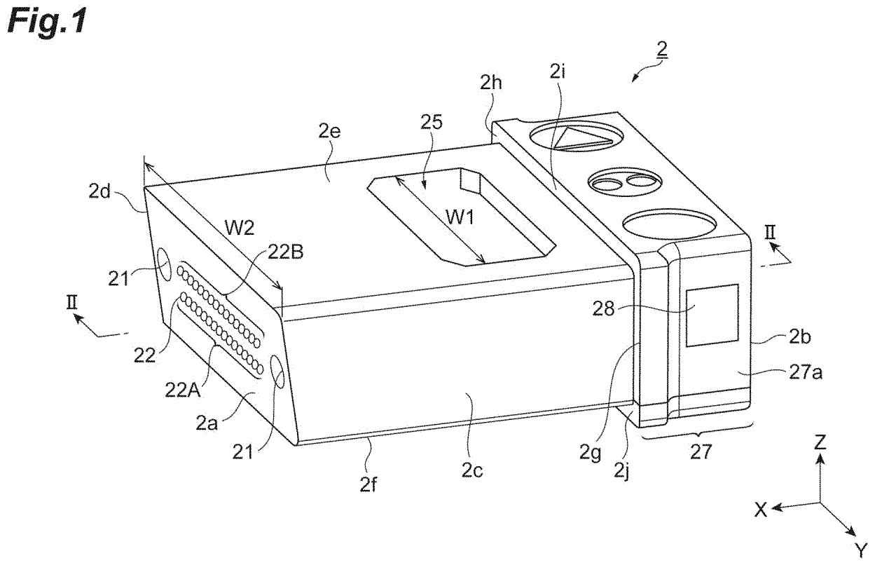

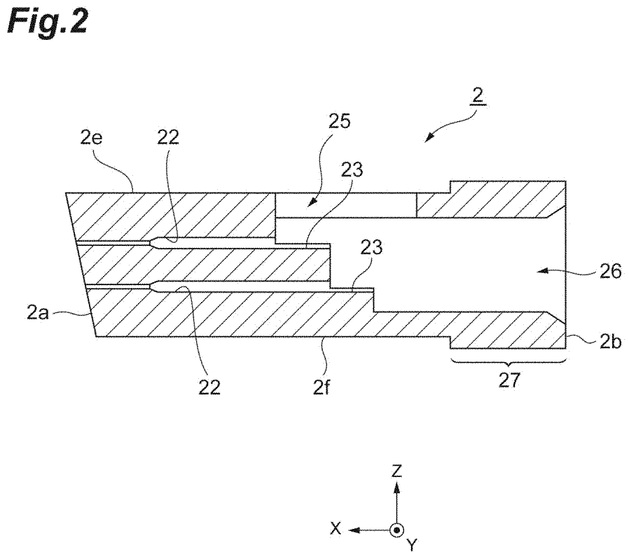

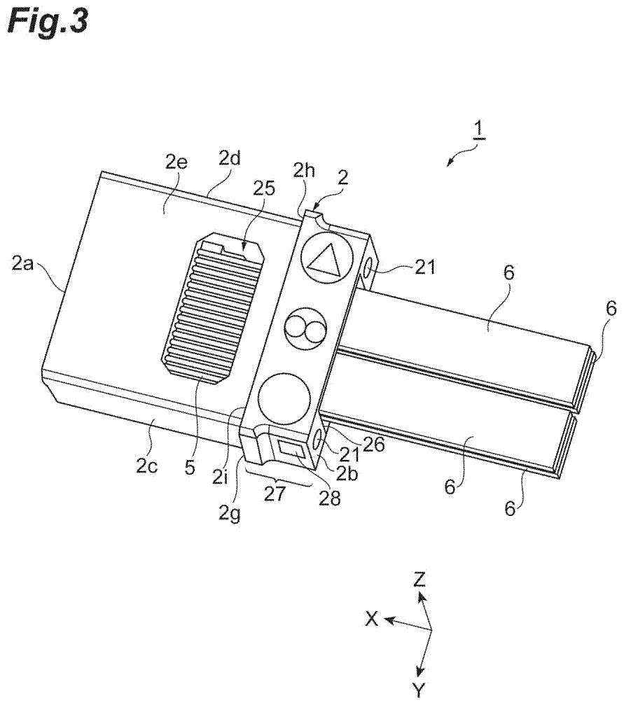

FIG. 1 is a perspective view illustrating an appearance of an optical connector ferrule 2 which is manufactured using a manufacturing method according to an embodiment. FIG. 2 is a sectional view illustrating a section taken along line II-II of the optical connector ferrule illustrated in FIG. 1. FIG. 3 is a perspective view illustrating an appearance of an optical fiber 1 with a connector including the optical connector ferrule 2. For the purpose of easy understanding, an XYZ orthogonal coordinate system is illustrated in the drawings. In this embodiment, an X-axis direction is defined as a first direction. A Y-axis direction is defined as a second direction crossing the first direction. A Z-axis direction is defined as a third direction crossing the first direction and the second direction. In the following description, a side facing an optical connector which is an opposite party is referred to as a front side. A side on which the optical fibers are dragged is referred to as a rear side. The X axis extends from the rear side to the front side.

The optical connector ferrule 2 is an optical connector member formed of a resin. The optical connector ferrule 2 is, for example, an MT optical connector ferrule. The resin is, for example, a polyphenylene sulfide (PPS) resin. As illustrated in FIGS. 1 and 2, the optical connector ferrule 2 has a substantially rectangular parallelepiped shape extending in the X-axis direction. The optical connector ferrule 2 includes a front end surface (one end surface) 2a, a rear end surface (the other end surface) 2b, a pair of side surface 2c and side surface 2d, a front surface 2e, and a back surface 2f.

The front end surface 2a and the rear end surface 2b are arranged in the X-axis direction. The front end surface 2a and the rear end surface 2b face each other in the X-axis direction. More specifically, the normal line of the front end surface 2a is parallel to the X-axis direction. Alternatively, the normal line of the front end surface 2a is inclined with respect to the X-axis direction. The normal line of the rear end surface 2b is parallel to the X-axis direction. For example, an angle formed by the X-axis direction and the normal line of the front end surface 2a ranges from 10° to 20°. Alternatively, the angle formed by the X-axis direction and the normal line of the front end surface 2a may be 8°. The angle formed by the X-axis direction and the normal line of the front end surface 2a may be 0°. The front end surface 2a faces an optical connector which is an opposite party.

The side surface 2c and the side surface 2d which form a pair are arranged in the Y-axis direction. The side surface 2c and the side surface 2d face each other in the Y-axis direction. More specifically, the side surface 2c and the side surface 2d are parallel to each other. The side surface 2c and the side surface 2d extend in the X-axis direction. For example, the side surface 2c and the side surface 2d extend in an XZ plane. The front surface 2e and the back surface 2f are arranged in the Z-axis direction. The front surface 2e and the back surface 2f face each other in the Z-axis direction. More specifically, the front surface 2e and the back surface 2f are parallel to each other. The front surface 2e and the back surface 2f extend in the X-axis direction. For example, the front surface 2e and the back surface 2f extend in an XY plane.

The optical connector ferrule 2 includes two guide holes 21, N₁ optical fiber holding holes 22, an introduction port 26, and a window hole 25. N₁ is an integer which is equal to or greater than 16. For example, in this embodiment, N₁=32 is defined. Guide pins are respectively inserted into the two guide holes 21. The two guide holes 21 are holes with a circular section extending in the X-axis direction. The guide holes 21 penetrate from the front end surface 2a to the rear end surface 2b. The optical fiber holding holes 22 are disposed between the two guide holes 21. The introduction port 26 is formed in the rear end surface 2b. The window hole 25 penetrates from the front surface 2e to the introduction port 26. The introduction port 26 introduces a plurality of optical fibers 5 (see FIG. 3) in a bundle in the X-axis direction.

The N₁ optical fiber holding holes 22 penetrate from the introduction port 26 to the front end surface 2a. The N₁ optical fiber holding holes 22 respectively hold the plurality of optical fibers 5. For example, N₁ optical fibers 5 which are exposed from an optical fiber ribbon 6 (see FIG. 3) are inserted into the N₁ optical fiber holding holes 22, respectively. In addition, the N₁ optical fibers 5 are fixed to the N₁ optical fiber holding holes 22. The tip face of each optical fiber 5 is exposed from the front end surface 2a. N₁ optical fiber grooves 23 are provided in the introduction port 26. The N₁ optical fiber grooves 23 extend continuously from the rear end of the N₁ optical fiber holding holes 22. The N₁ optical fiber grooves 23 serve as guides for inserting the optical fibers 5 into the optical fiber holding holes 22. N₂ optical fiber holding holes 22 (where N₂ is an integer which is equal to or greater than 16 and N₂=16 is defined in this embodiment) out of the N₁ optical fiber holding holes 22 are arranged in the Y-axis direction and constitute an optical fiber holding hole array 22A of a first stage. N₃ optical fiber holding holes 22 (where N₃ is an integer which is equal to or greater than 16 and N₂+N₃=N₁ is satisfied) out of the N₁ optical fiber holding holes 22 are arranged in the Y-axis direction and constitute an optical fiber holding hole array 22B of a second stage. The optical fiber holding hole array 22B of the second stage is disposed between the front surface 2e and the optical fiber holding hole array 22A of the first stage. At least one optical fiber holding hole array has only to be arranged in the Z-axis direction.

The window hole 25 is a hole for visual checking and injection of an adhesive at the time of inserting the optical fibers 5 into the optical fiber holding holes 22. The window hole 25 is located in the Z-axis direction with respect to the optical fiber grooves 23. A planar shape of the window hole 25 when seen in the Z-axis direction is, for example, a tetragonal shape or an octagonal shape. In this embodiment, the number of optical fiber holding holes 22 in each array is 16 which is large. Accordingly, an opening width W1 in the Y-axis direction of the window hole 25 on the front surface 2e is relatively large. As a result, the opening width W1 is equal to or greater than 60% of a gap W2 between the side surface 2c and the side surface 2d in the Y-axis direction. For example, when the gap W2 is 6.4 mm, the opening width W1 is equal to or greater than 3.9 mm. The opening width W1 is equal to or less than 90% of the gap W2 (equal to or less than 6.2 mm) due to constraint in mechanical strength of the side surface 2c and the side surface 2d.

The optical connector ferrule 2 further includes a flange portion 27 and a gate mark 28. The gate mark 28 is formed in the flange portion 27. The flange portion 27 is provided on the rear side of the optical connector ferrule 2. The flange portion 27 protrudes outward to form a stepped portion with respect to the outer circumferential surface of the optical connector ferrule 2. Specifically, a part of the flange portion 27 protrudes outward in the Y-axis direction from the side surface 2c and the side surface 2d. A part of the flange portion 27 constitutes a stepped portion 2g on the side surface 2c. A part of the flange portion 27 constitutes a stepped portion 2h on the side surface 2d. The other part of the flange portion 27 protrudes outward in the Z-axis direction from the front surface 2e and the back surface 2f. The other part of the flange portion 27 constitutes a stepped portion 2i on the front surface 2e. The other part of the flange portion 27 constitutes a stepped portion 2j on the back surface 2f. In this embodiment, a part of the flange portion 27 close to the rear end is recessed to the inside of the optical connector ferrule 2. A part of the flange portion 27 close to the rear end constitutes a recessed portion 27a.

The gate mark 28 is a mark which is formed at the time of injection molding of the optical connector ferrule 2. A planar shape the gate mark 28 is, for example, a substantially rectangular shape in which a long-side direction is parallel to the Z-axis direction and a short-side direction is parallel to the X-axis direction. The gate mark 28 can have various shapes other than a flat surface which can be distinguished from the recessed portion 27a such as a convex shape or a concave shape. The gate mark 28 is formed on the side surface 2c and the side surface 2d. The side surface 2c and the side surface 2d is located closer to the rear end surface 2b with respect to the rear edge of the window hole 25 in the X-axis direction. In this embodiment, the gate mark 28 is formed on the recessed portion 27a of the flange portion 27 on the side surface 2c and the side surface 2d. The gate mark 28 may be formed on a part other than the recessed portion 27a of the flange portion 27 on the side surface 2c and the side surface 2d. For example, the gate mark 28 may be formed between the flange portion 27 and the rear end surface 2b on the side surface 2c and the side surface 2d. The planar shape of the gate mark 28 may be various shapes such as a circular shape or an elliptical shape other than the substantially rectangular shape.

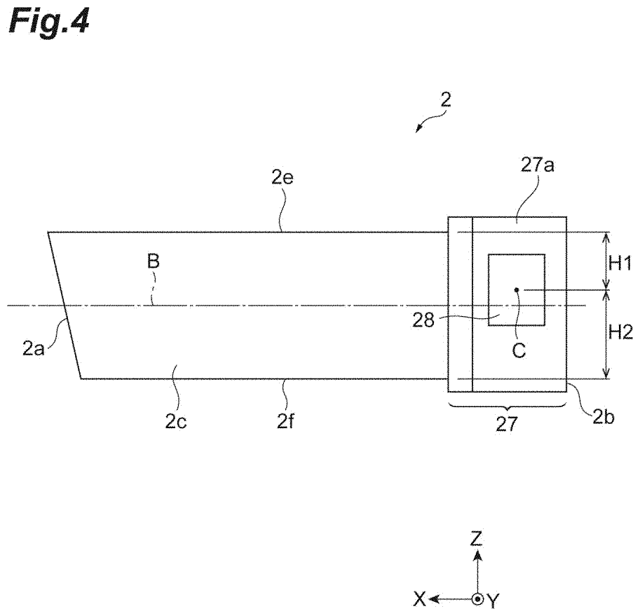

FIG. 4 is a side view of the optical connector ferrule 2. As illustrated in FIG. 4, the gate mark 28 is disposed close to the front surface 2e in the Z-axis direction. A distance between the center point C of the gate mark 28 and the front surface 2e in the Z-axis direction is defined as a distance H1. A distance between the center point C of the gate mark 28 and the rear surface 2f in the Z-axis direction is defined as a distance H2. Then, the distance H1 is less than the distance H2. For example, a distance between the center position of the gate mark 28 and a plane B which is separated equally from the front surface 2e and the rear surface 2f in the Z-axis direction is equal to or greater than 0.1 mm or more and is equal to or less than 1.25 mm. The size of the gate mark 28 in the X-axis direction is, for example, equal to or greater than 0.5 mm and equal to or less than 1.2 mm. The size of the gate mark 28 in the Z-axis direction is, for example, equal to or greater than 0.5 mm and equal to or less than 2.5 mm.

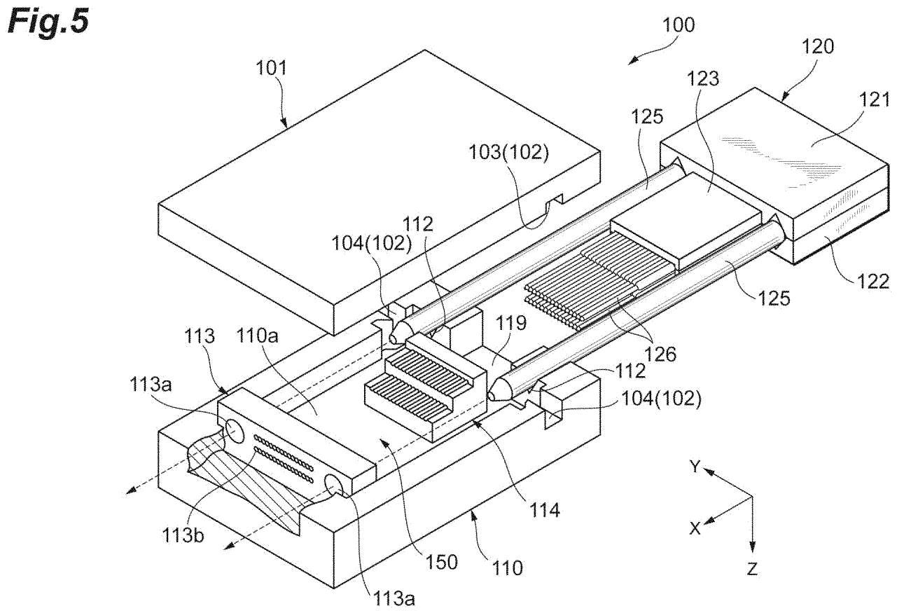

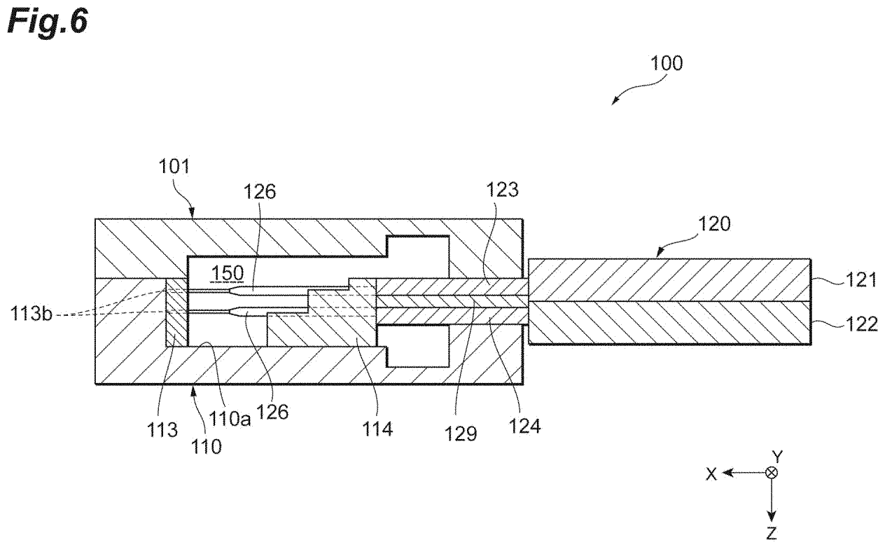

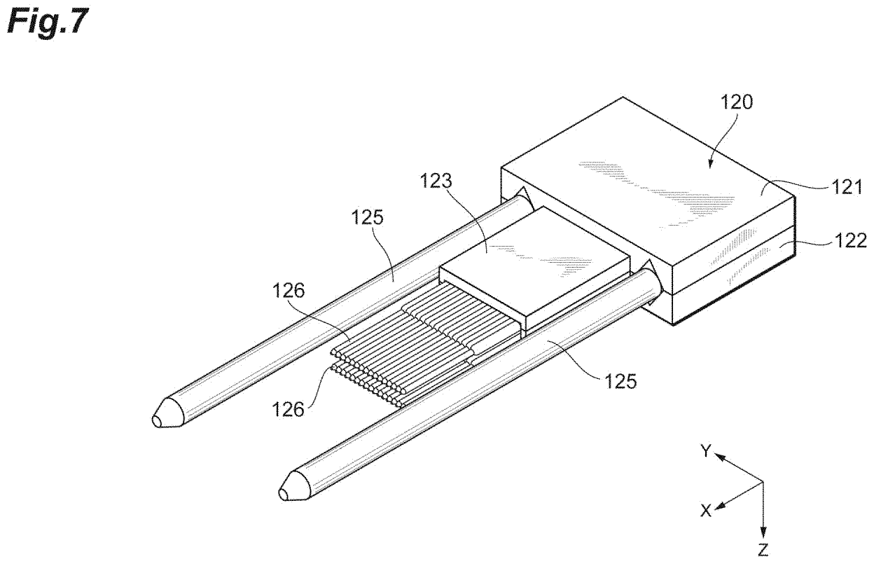

A die for molding an optical connector ferrule will be described below with reference to FIGS. 5, 6, and 7. The die for molding an optical connector ferrule is used to mold the optical connector ferrule 2. FIG. 5 is an exploded perspective view of the die for molding an optical connector ferrule which is used to mold the optical connector ferrule 2. In the following description, the die for molding an optical connector ferrule is simply referred to as a molding die 100. FIG. 6 is a sectional view of the molding die 100. FIG. 6 illustrates a side section taken along the XZ plane of the molding die 100. FIG. 7 is a perspective view illustrating an internal structure (a middle die 120) of the molding die 100.

As illustrated in FIGS. 5, 6, and 7, the molding die 100 includes an upper die 101, a lower die 110, and a middle die 120. The upper die 101 and the lower die 110 form a cavity (an internal space) 150. The cavity 150 is a space into which a molten resin is introduced with the middle die 120 therein. The lower die 110 includes a bottom surface 110a. The bottom surface 110a is parallel to the XY plane and defines the cavity 150 of the molding die 100. Two guide hole forming pins 125 are disposed in the middle die 120 to protrude in the X-axis direction. The two guide hole forming pins 125 form the guide holes 21 (see FIG. 1) of the optical connector ferrule 2. N₁ optical fiber hole forming pins 126 are disposed to protrude in the X-axis direction between the two guide hole forming pins 125. The optical fiber hole forming pins 126 form the optical fiber holding holes 22 of the optical connector ferrule 2. The N₁ optical fiber hole forming pins 126 extend along the bottom surface 110a. Base ends of the guide hole forming pins 125 and the optical fiber hole forming pins 126 are interposed and held between a pair of holding member 121 and holding member 122. The base ends of the optical fiber hole forming pins 126 are additionally held by an upper holding member 123, a lower holding member 124, and a spacer 129. The upper holding member 123, the lower holding member 124, and the spacer 129 are thinner than the holding member 121 and the holding member 122. The upper holding member 123, the lower holding member 124, and the spacer 129 are held, for example, by the holding member 121 and the holding member 122. The holding member 121 and the holding member 122 are fixed to each other, for example, by a fastening screw. The upper holding member 123, the lower holding member 124, and the spacer 129 form the introduction port 26 illustrated in FIG. 2.

Two V-shaped grooves 112 are formed on the side wall on the rear side of the lower die 110. The two V-shaped grooves 112 position the two guide hole forming pins 125, respectively. An accommodation recessed portion 119 is formed between the two V-shaped grooves 112. The accommodation recessed portion 119 positions the upper holding member 123, the lower holding member 124, and the spacer 129. A pin holding member 113 is disposed on the side wall on the front side of the lower die 110. Two insertion holes 113a and N₁ insertion holes 113b are formed in the pin holding member 113. The insertion holes 113a respectively accommodate and fix the tips of the two guide hole forming pins 125. The insertion holes 113b respectively accommodate and fix the tips of the N₁ optical fiber hole forming pins 126.

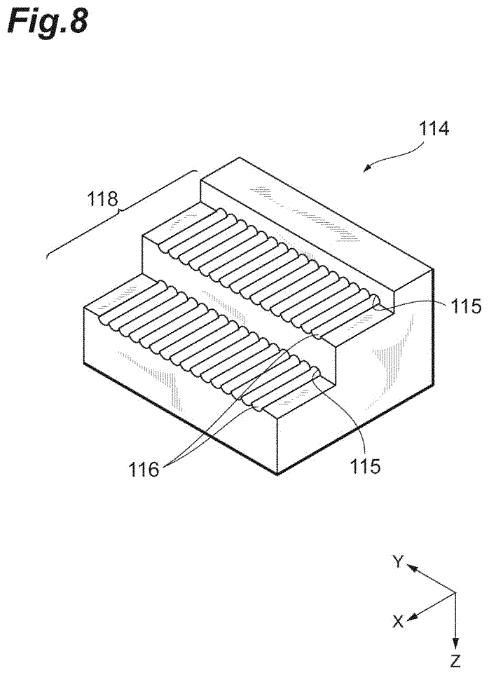

A protruding portion 114 is provided at the center of the bottom surface 110a of the lower die 110. The protruding portion 114 forms the window hole 25 (see FIGS. 1 and 2) in the optical connector ferrule 2. FIG. 8 is an enlarged perspective view of the protruding portion 114. N₁ insertion holes 115 are fowled in the protruding portion 114. The insertion holes 115 accommodates the base ends of the optical fiber hole forming pins 126, respectively. A stepped portion 118 is formed in a front part of the upper end of the protruding portion 114. A C-shaped groove 116 of which the top is open is formed in a part in front of each insertion hole 115. A semicylindrical portion of each cylinder of the base end portion of the optical fiber hole forming pin 126 accommodated in and fixed to each C-shaped groove 116 is covered with the C-shaped groove 116.

As illustrated in FIG. 5, the molding die 100 further includes a pair of gates 102. The pair of gates 102 serves as a filling port of a molten resin when the dies are closed. The gates 102 are disposed at positions corresponding to the side surfaces 2c and 2d, respectively. The gates 102 are disposed at positions corresponding to the rear end surface 2b with respect to the window hole 25 in the X-axis direction. That is, the gates 102 are disposed at positions behind the protruding portion 114. In this embodiment, the gates 102 are for lied at positions corresponding to the recessed portion 27a of the flange portion 27 on the side surface 2c and the side surface 2d. Similarly to the gate marks 28, the gates 102 may be provided at positions corresponding to a part other than the recessed portion 27a of the flange portion 27 on the side surface 2c and the side surface 2d. The gates 102 may be provided at positions corresponding to the side surface 2c and the side surface 2d between the flange portion 27 and the rear end surface 2b. The gates 102 form the gate marks 28. The gates 102 have the same opening shape as the planar shape of the gate marks 28. The gates 102 in this embodiment is formed by coupling a cutout portion 103 formed in the upper die 101 and a cutout portion 104 formed in the lower die 110. The gates 102 may be provided on only the lower die 110 side.

The gates 102 are provided with positions and side. corresponding to the gate marks 28. That is, the gates 102 are disposed relatively close to the front surface 2e (that is, the bottom surface 110a) in the Z-axis direction. Specifically, a distance between the center of the gates 102 and the front surface 2e (the bottom surface 110a) in the Z-axis direction is less than a distance between the center of the gates 102 and the back surface 2f (that is, the bottom surface of the upper die 101) in the same direction. For example, a distance between the center position of the gates 102 and a plane which is separated equally from the front surface 2e and the back surface 2f in the Z-axis direction is equal to or greater than 0.1 mm and equal to or less than 1.25 mm. The inner width of the gates 102 in the X-axis direction is, for example, equal to or greater than 0.5 mm and equal to or less than 1.2 mm. The inner width of the gates 102 in the Z-axis direction is, for example, equal to or greater than 0.5 mm and equal to or less than 2.5 mm.

The optical connector ferrule 2 is manufactured using the molding die 100 having the above-mentioned configuration. First, the guide hole forming pins 125 and the optical fiber hole forming pins 126 are held by the holding member 121 and the holding member 122. Then, the middle die 120 is extruded toward the tips of the guide hole forming pins 125 and the optical fiber hole forming pins 126. By this extruding, the guide hole forming pins 125 and the optical fiber hole forming pins 126 are inserted into the insertion holes 113a and the insertion holes 113b of the pin holding member 113. At this time, the optical fiber hole forming pins 126 are also inserted into the insertion holes 115 of the protruding portion 114. Then, the tip end surfaces of the upper holding member 123 and the lower holding member 124 come into contact with end surfaces on the accommodation recessed portion 119 side of the protruding portion 114. In this state, the upper die 101 and the lower die 110 are closed as illustrated in FIG. 6. At this time, the upper die 101 and the lower die 110 may be fixed to each other. After the upper die 101 and the lower die 110 are temporarily closed and the middle die 120 is inserted, the upper die 101 and the lower die 110 may be fixed to each other.

As the result of fixation, the cavity 150 is foamed by the upper die 101, the lower die 110, and the middle die 120. The cavity 150 corresponds to the shape of the optical connector ferrule 2. Then, a molten resin is introduced into the cavity 150 via the gates 102. For example, PPS is used as the molten resin. After the resin in the cavity 150 has been cured, the upper die 101 and the lower die 110 are unfixed. Subsequently, the middle die 120 is pulled out. Then, the upper die 101 and the lower die 110 are opened. As a result, the optical connector ferrule 2 illustrated in FIGS. 1 and 2 is obtained. Thereafter, the front end surface 2a is polished such that the angle formed by the center axis of the optical fiber holding holes 22 and the not mal line of the front end surface 2a in the Z-axis direction reaches a desired angle. The desired angel is, for example, equal to or greater than 10° and equal to or less than 20°. Alternatively, the desired angle may be 8°. The desired angle may be 0°.

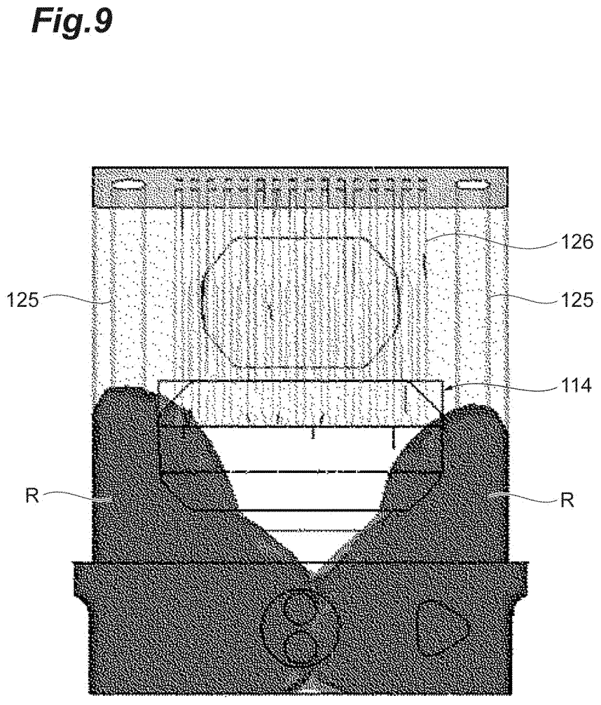

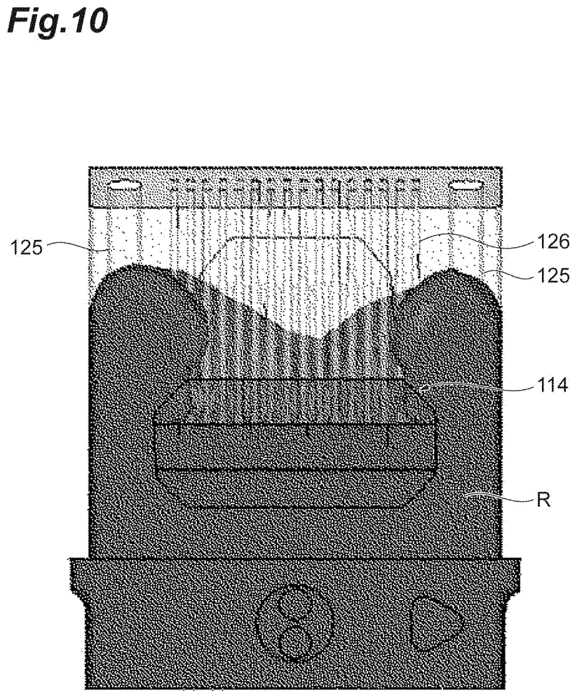

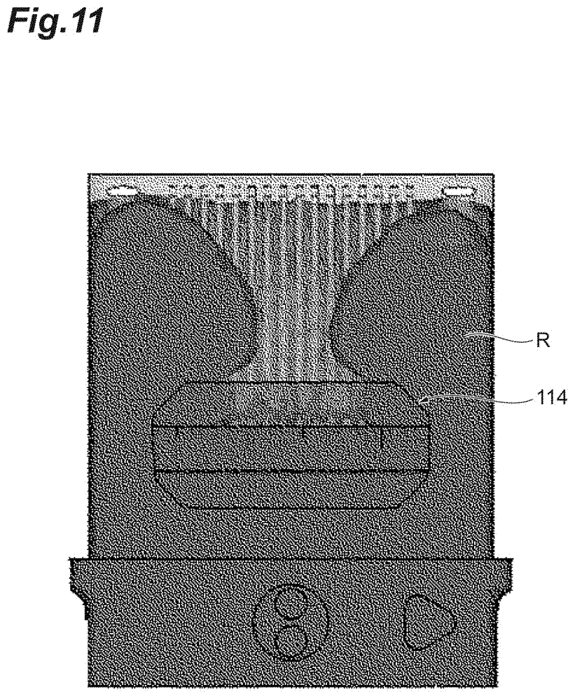

Advantageous effects obtained from the optical fiber 1 with a connector, the optical connector ferrule 2, and the manufacturing method thereof according to this embodiment will be described below. For example, in the method described in Patent Literature 1, the gates of the die which are disposed in the flange portion are disposed at equal distances from the front surface and the back surface. In this case, a flow of a molten resin on the front surface side is delayed by a die for a window hole which is provided on only the front surface side. A flow of a molten resin on the back surface side speeds up relatively. As a result, injection pressures are connected unevenly. FIGS. 9, 10, and 11 are diagrams illustrating the results of simulation of the flow of the molten resin R. FIGS. 9, 10, and 11 illustrate the results when gates for a die with 16 cores per stage (total 32 cores in two stages) are disposed at equal distances from the front surface and the back surface. FIG. 9 illustrates a state immediately after the molten resin R has been introduced. FIG. 10 illustrates a state when a predetermined time has elapsed after the molten resin has been introduced. FIG. 11 illustrates a state when a more time has elapsed. When the molten resin R is introduced via the gates, the molten resin R is divided into two vertical parts by the holding member 123 and the holding member 124 that hold the optical fiber hole forming pins and flow in the cavity 150. At this time, the flow of the molten resin R flowing on the upper side is hindered by the die (the protruding portion 114) for the window hole 25. As a result, since the flow of the molten resin R is deflected, the injection pressure in the cavity 150 is vertically uneven. By this unevenness in injection pressure, inclination of the optical fiber hole forming pins 126, an internal stress at the time of curing the molten resin R, and the like are caused. As a result, the center axis direction of the optical fiber holding holes 22 is inclined with respect to the Z-axis direction. The inclination of the center axis direction causes displacement of the tip faces of the optical fibers held in the optical fiber holding holes 22 (see FIG. 25). The displacement of the opening positions serves as a factor for an increase in connection loss between the optical connectors.

On the other hand, in this embodiment, the gates 102 of the molding die 100 (or the gate marks 28 of the optical connector ferrule 2) are disposed on the side surface 2c and the side surface 2d which are located close to the rear end surface 2b with respect to the window hole 25 in the X-axis direction. The distance H1 between the center of the gates 102 (the gate marks 28) and the front surface 2e in the Z-axis direction is less than the distance H2 between the center of the gates 102 (the gate marks 28) and the back surface 2f in the Z-axis direction. In this way, by setting the positions of the gates 102 (the gate marks 28) in the Z-axis direction to be closer to the front surface 2e, balance of the molten resin flow between the front surface 2e side and the back surface 2f side is improved. As a result, it is possible to reduce unevenness in injection pressure.

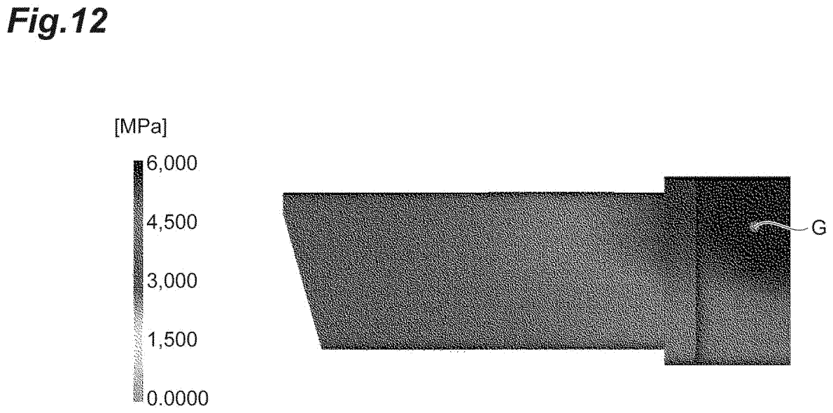

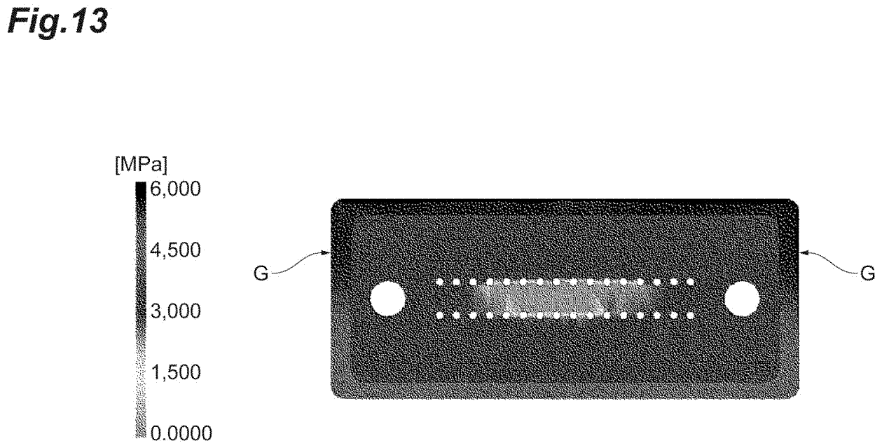

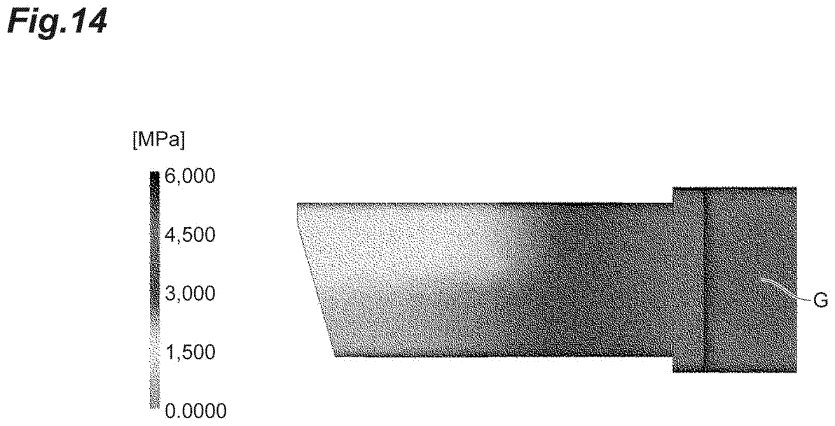

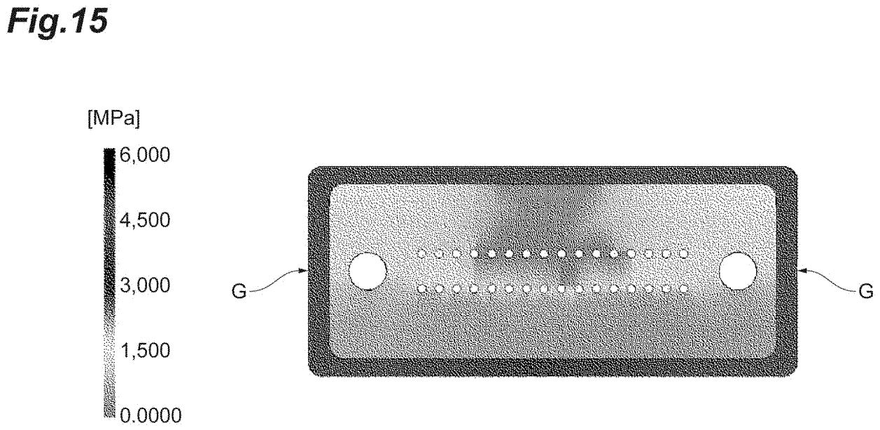

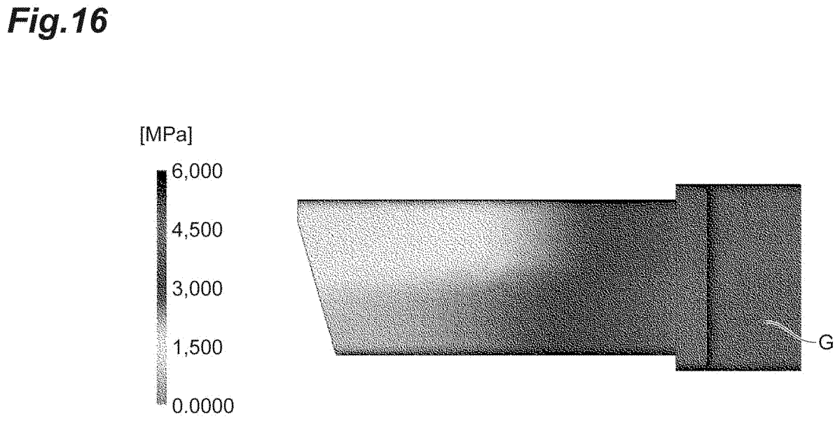

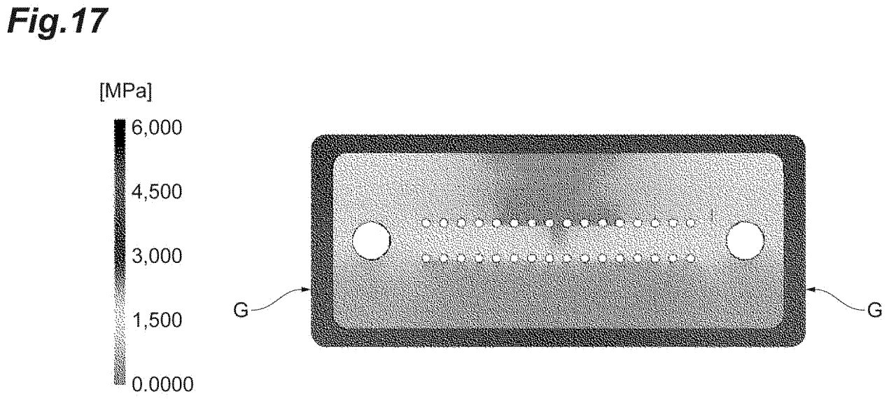

FIGS. 12, 13, 14, 15, 16, and 17 are diagrams illustrating flow analysis results associated with an injection pressure. Gradation of a color indicates the magnitude of the injection pressure. As a color becomes darker, the injection pressure becomes larger. A gate center position G is illustrated in the drawings. FIGS. 12 and 13 illustrate a case in which the gate center position G is closer to the front surface 2e. Specifically, the gate center position G is +0.7 mm from the plane B in the Z-axis direction. FIGS. 14 and 15 illustrate a case in which the gate center position G is located at equal distances from the front surface 2e and the back surface 2f. FIGS. 16 and 17 illustrate a case in which the gate center position G is closer to the back surface 2f. Specifically, the gate center position G is −0.7 mm from the plane B in the Z-axis direction. FIGS. 12, 14, 16 illustrate analysis results when seen from one side surface. FIGS. 13, 15, and 17 illustrate analysis results when seen from the front surface.

When the gate center position G is closer to the back surface 2f (FIGS. 16 and 17) or when the gate center position G is separated equally from the front surface 2e and the back surface 2f (FIGS. 14 and 15), the injection pressure on the front surface 2e side of the cavity is less than the injection pressure on the back surface 2f side. On the other hand, when the gate center position G is closer to the front surface 2e (FIGS. 12 and 13), the injection pressure of the front surface 2e side of the cavity is greater than that when the gate center position G is closer to the back surface 2f (FIGS. 16 and 17) and when the gate center position G is separated equally from the front surface 2e and the back surface 2f (FIGS. 14 and 15). The injection pressure on the back surface 2f side is less than that when the gate center position G is closer to the back surface 2f (FIGS. 16 and 17) and when the gate center position G separated equally from the front surface 2e and the back surface 2f (FIGS. 14 and 15). Accordingly, the injection pressure on the front surface 2e side and the injection pressure on the back surface 2f side of the cavity become close to each other.

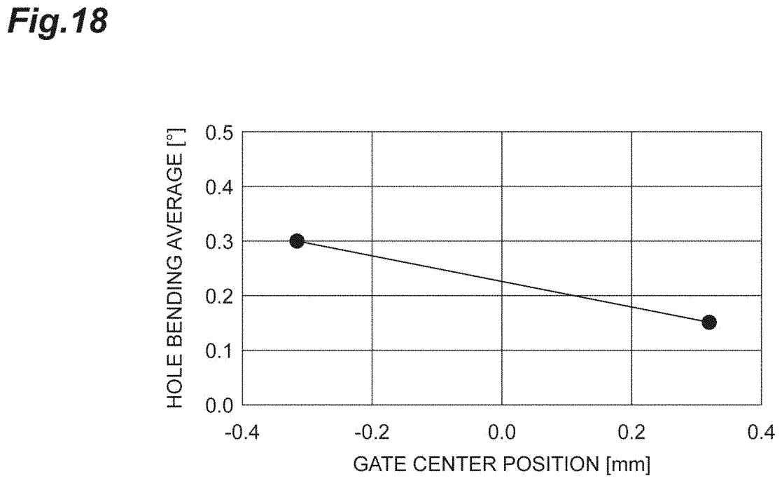

FIG. 18 is a graph illustrating an example of a relationship between a vertical position of the gate center position G with respect to the plane B (the horizontal axis) and an inclination angle of the center axis direction of the optical fiber holding holes 22 on the front end surface 2a with respect to the X-axis direction (the vertical axis). In this example, the optical connector ferrule 2 was actually manufactured when the gate center position G was set to −0.32 mm from the plane B in the Z-axis direction and when the gate center position G was set to +0.32 mm from the plane B in the Z-axis direction. Then, the inclination angle of the center axis direction of the optical fiber holding holes 22 was measured. As illustrated in FIG. 18, when the gate center position G was set to be closer to the front surface 2e, the inclination angle was clearly less than that when the gate center position G was set to be closer to the back surface 2f.

In this way, according to this embodiment, the inclination of the center axis direction of the optical fiber holding holes 22 is decreased by reducing unevenness in injection pressure. According to this embodiment, it is possible to reduce displacement of the opening position of the optical fiber holding holes 22 after being polished. Accordingly, it is possible to curb an increase in connection loss between the optical connectors. In the optical connector ferrule 2, it can be visually ascertained that the gate marks 28 are closer to the front surface 2e than the back surface 2f. As a result, it is possible to easily determine whether it is an optical connector ferrule which is manufactured using the method capable of curbing an increase in connection loss. In other words, it is possible to easily determine whether it is an optical connector ferrule with high dimensional accuracy.

As in this embodiment, the opening width W1 in the Y-axis direction of the window hole 25 on the front surface 2e may range from 60% to 90% of the gap W2 between the side surface 2c and the side surface 2d in the Y-axis direction. When the opening width W1 in the Y-axis direction of the window hole 25 is equal to or greater than 60% of the side gap W2, the die for forming the window hole 25 is thickened. As a result, the flow of the molten resin is likely to be hindered. Accordingly, the optical fiber 1 with a connector, the optical connector ferrule 2, and the manufacturing method thereof according to this embodiment are particularly effective.

As in this embodiment, the opening width W1 may range from 3.9 mm to 6.2 mm. The distance between the center position G of the gates 102 and the plane B in the Z-axis direction may range from 0.1 mm to 1.25 mm. For example, when 16 optical fibers are arranged at pitches of 0.25 mm in the Y-axis direction, the horizontal width of the optical fiber bundle in the Y-axis direction is 3.875 mm. When the opening width W1 of the window hole 25 is equal to or greater than 3.9 mm, the die for forming the window hole 25 is also thickened. As a result, the flow of the molten resin is likely to be hindered. In this case, the optical fiber 1 with a connector, the optical connector ferrule 2, and the manufacturing method thereof according to this embodiment are particularly effective. The distance between the center position of the gate marks 28 and the plane B in the Z-axis direction is equal to or greater than 0.1 mm. As a result, it is possible to enhance visibility when it is determined whether it is an optical connector ferrule 2 manufactured using a method capable of curbing an increase in connection loss. In other words, it is possible to enhance visibility when it is determined whether it is an optical connector ferrule 2 with high dimensional accuracy.

As in this embodiment, at least one optical fiber holding hole array including 16 or more optical fiber holding holes 22 which are arranged in the Y-axis direction may be arranged in the Z-axis direction. According to this arrangement, since the opening width W1 of the window hole 25 is increased, the die (the protruding portion 114) for forming the window hole 25 is thickened. As a result, the flow of the molten resin is likely to be hindered. In this case, the optical fiber 1 with a connector, the optical connector ferrule 2, and the manufacturing method thereof according to this embodiment are particularly effective.

As in this embodiment, the size of the gates 102 (the gate marks 28) in the X-axis direction may range from 0.5 mm to 1.2 mm. The size of the gates 102 (the gate marks 28) in the Z-axis direction may range from 0.5 mm to 2.5 mm. The gates 102 (the gate marks 28) has a sufficient size. As a result, it is possible to easily check displacement of the center position of the gate marks 28 in the Z-axis direction with eyes.

As in this embodiment, the resin for forming the optical connector ferrule 2 may be PPS. By using PPS, it is possible to realize an optical connector ferrule 2 with high dimensional accuracy and with excellent mechanical strength.

As in the manufacturing method according to this embodiment, a step of polishing the front end surface 2a may be provided such that the angle formed by the center axis of the plurality of optical fiber holding holes 22 and the normal line of the front end surface 2a is equal to or greater than 10° and equal to or less than 20°. Similarly, in the optical connector ferrule 2, the angle formed by the center axis of the plurality of optical fiber holding holes 22 and the normal line of the front end surface 2a may be equal to or greater than 10° and equal to or less than 20°. As the inclination angle of the front end surface 2a increases, an amount of polishing increases. As a result, when the center axis direction of the optical fiber holding holes 22 is inclined, displacement of the opening position of the optical fiber holding holes 22 after being polished increases. Accordingly, the optical fiber 1 with a connector, the optical connector ferrule 2, and the manufacturing method thereof are particularly effective.

The method of manufacturing an optical connector ferrule, the optical connector ferrule, and the optical fiber with a connector according to the present disclosure are not limited to the above-mentioned embodiment and can be modified in various forms. For example, the number of optical fiber holding holes per stage is set to 16 in the above-mentioned embodiment. The number of optical fiber holding holes per stage in the present disclosure is not limited 16. For example, the number of optical fiber holding holes per stage may be greater than 16. The number of optical fiber holding holes per stage may be less than 16.

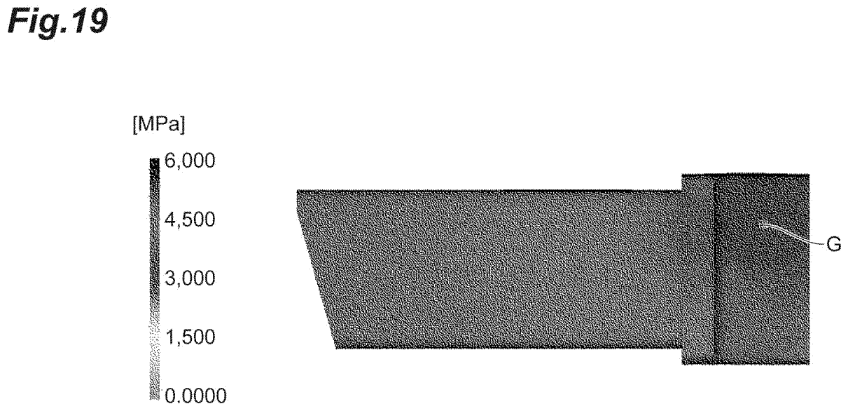

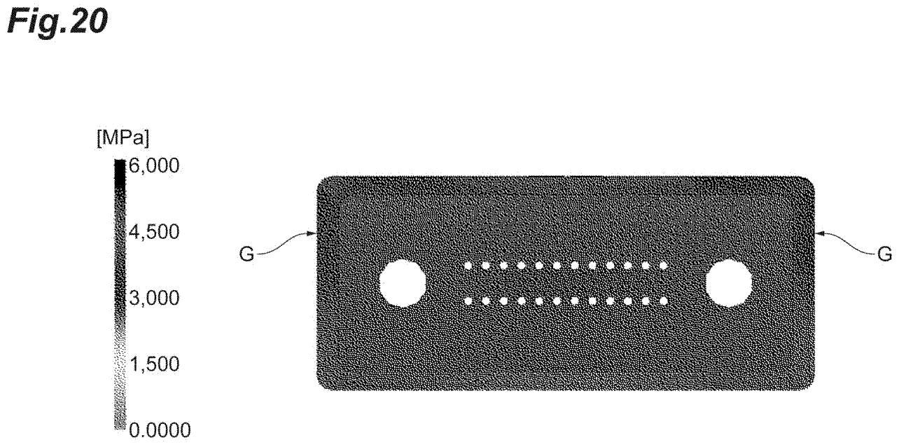

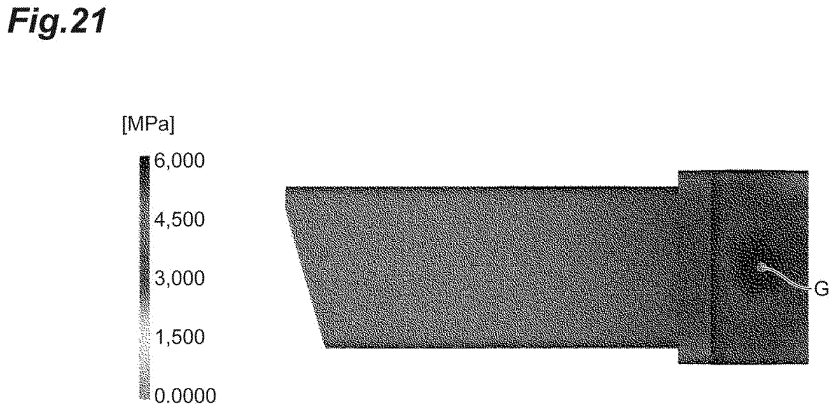

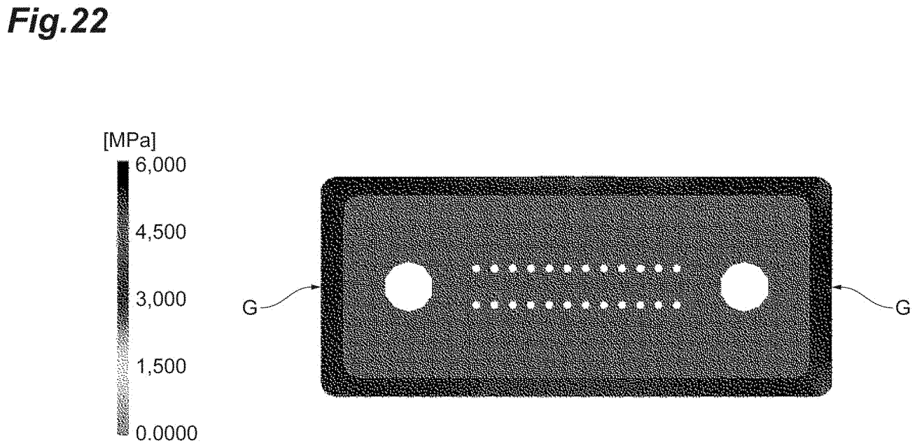

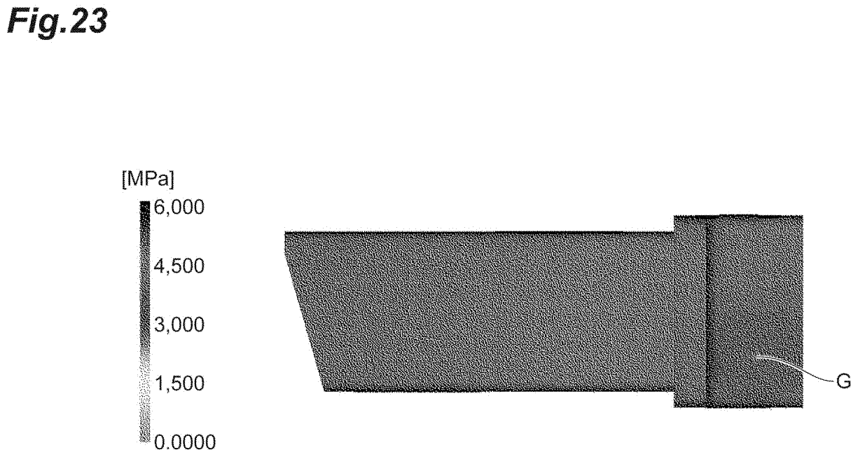

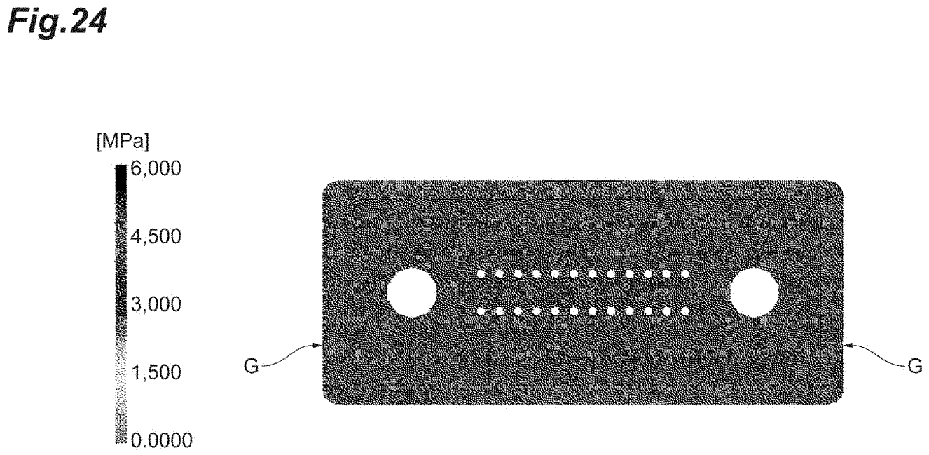

FIGS. 19, 20, 21, 22, 23, and 24 are diagrams illustrating flow analysis results associated with injection pressures when the number of optical fiber holding holes per stage is set to 12 (total 24). FIGS. 19 and 20 illustrate a case in which the gate center position G is closer to the front surface 2e. Specifically, the gate center position G is +0.7 nun from the plane B in the Z-axis direction. FIGS. 21 and 22 illustrate a case in which the gate center position G is located at equal distances from the front surface 2e and the back surface 2f. FIGS. 23 and 24 illustrate a case in which the gate center position G is closer to the back surface 2f. Specifically, the gate center position G is −0.7 mm from the plane B in the Z-axis direction. FIGS. 19, 21, 23 illustrate analysis results when seen from one side surface. FIGS. 20, 22, and 24 illustrate analysis results when seen from the front surface.

As illustrated in FIGS. 21, 22, 23, and 24, when the number of optical fiber holding holes per stage is set to 12, the difference in injection pressure between the front surface 2e side and the back surface 2f side is less than that when the number of optical fiber holding holes per stage is set to 16 (FIGS. 12, 13, 14, 15, 16, and 17). This is because, since the horizontal width of the window hole decreases due to the decrease in the number of optical fiber holding holes per stage, the horizontal width of the protruding portion 114 decreases. However, when the gate center position G is closer to the back surface 2f or the gate center position G is located at equal distances from the front surface 2e and the back surface 2f, the injection pressure on the front surface 2e side in the cavity is less than the injection pressure on the back surface 2f side. On the other hand, when the gate center position G is closer to the front surface 2e (FIGS. 19 and 20), the injection pressure on the front surface 2e side in the cavity is greater in comparison with those in FIGS. 21, 22, 23, and 24. As a result, the injection pressure on the back surface 2f side is less in comparison with those in FIGS, 21, 22, 23, and 24. Accordingly, the injection pressure on the front surface 2e side and the injection pressure on the back surface 2f side in the cavity approach each other. Accordingly, it is possible to obtain the advantageous effects as in the above-mentioned embodiment.

### REFERENCE SIGNS LIST

1 . . . Optical fiber with connector, 2 . . . Optical connector ferrule, 2a . . . Front end surface, 2b . . . Rear end surface, 2c, 2d . . . Side surface, 2e . . . Front surface, 2f . . . Back surface, 5 . . . Optical fiber, 6 . . . Optical fiber ribbon, 21 . . . Guide hole, 22 . . . Optical fiber holding hole, 22A . . . Optical fiber holding hole array, 22B . . . Optical fiber holding hole array, 23 . . . Optical fiber groove, 25 . . . Window hole, 26 . . . Introduction port, 27 . . . Flange portion, 27a . . . Recessed portion, 28 . . . Gate mark, 100 . . . Molding die, 101 . . . Upper die, 102 . . . Gate, 103 . . . Cutout portion, 104 . . . Cutout portion, 110 . . . Lower die, 110a . . . Bottom surface, 112 . . . V-shaped groove, 113 . . . Pin holding member, 113a, 113b . . . Insertion hole, 114 . . . Protruding portion, 115 . . . Insertion hole, 116 . . . C-shaped groove, 118 . . . Stepped portion, 119 . . . Accommodation recessed portion, 120 . . . Middle die, 121 . . . Holding member, 123 . . . Upper holding member, 124 . . . Lower holding member, 125 . . . Guide hole forming pin, 126 . . . Optical fiber hole forming pin, 129 . . . Spacer, 150 . . . Cavity, 201 . . . End surface, 202 . . . Optical fiber holding hole, B . . . Plane, C . . . Center point, C1 . . . Center axis, G . . . Gate center position, R . . . Molten resin, W1 . . . Opening width, W2 . . . Gap between side surfaces

1. A method of manufacturing an optical connector ferrule formed of a resin, comprising
a step of forming the optical connector ferrule by introducing the resin into a cavity of a die which includes the cavity corresponding to a shape of the optical connector ferrule and curing the resin,
wherein the optical connector ferrule includes:
one end surface and another end surface that are opposite to each other in a first direction;
a pair of side surfaces that are opposite to each other in a second direction which crosses the first direction;
a front surface and a back surface that are opposite to each other in a third direction which crosses the first direction and the second direction;
an introduction port that is formed on the other end surface and introduces a plurality of optical fibers in the first direction in a bundle;
a plurality of optical fiber holding holes that penetrate from the introduction port to the one end surface and hold each of the plurality of optical fibers; and
a window hole that penetrates from the front surface to the introduction port,
wherein a gate of the die is disposed on the pair of side surfaces which are located on the other end surface side with respect to the window hole in the first direction, and
wherein a distance between a center of the gate and the front surface in the third direction is less than a distance between the center of the gate and the back surface in the third direction.

2. The method of manufacturing an optical connector ferrule according to claim 1, wherein an opening width of the window hole in the second direction on the front surface is in a range of 60% to 90% of a gap between the pair of side surfaces in the second direction.

3. The method of manufacturing an optical connector ferrule according to claim 1, wherein an opening width of the window hole in the second direction on the front surface is in a range of 3.9 mm to 6.2 mm, and
wherein a distance between a center position of the gate and a plane which is separated by an equal distance from the front surface and the back surface in the third direction is in a range of 0.1 mm to 1.25 mm.

4. The method of manufacturing an optical connector ferrule according to claim 1, wherein at least one optical fiber holding hole array including 16 or more optical fiber holding holes which are arranged in the second direction is arranged in the third direction.

5. The method of manufacturing an optical connector ferrule according to claim 1, wherein a size of the gate in the first direction is in a range of 0.5 mm to 1.2 mm and a size of the gate in the third direction is in a range of 0.5 mm to 2.5 mm.

6. The method of manufacturing an optical connector ferrule according to claim 1, wherein the resin is a polyphenylene sulfide resin.

7. The method of manufacturing an optical connector ferrule according to claim 1, further comprising a step of polishing the one end surface such that an angle which is formed by a center axis of the plurality of optical fiber holding holes and a normal line of the one end surface is in a range of 10° to 20°.

8. The method of manufacturing an optical connector ferrule according to claim 1, further comprising a step of polishing the one end surface such that an angle which is formed by a center axis of the plurality of optical fiber holding holes and a normal line of the one end surface is 8°.

9. The method of manufacturing an optical connector ferrule according to claim 1, further comprising a step of polishing the one end surface such that an angle which is formed by a center axis of the plurality of optical fiber holding holes and a normal line of the one end surface is 0°.

10. An optical connector ferrule formed of a resin, comprising:
one end surface and another end surface that are opposite to each other in a first direction;
a pair of side surfaces that are opposite to each other in a second direction which crosses the first direction;
a front surface and a back surface that are opposite to each other in a third direction which crosses the first direction and the second direction;
an introduction port that is formed on the other end surface and introduces a plurality of optical fibers in the first direction in a bundle;
a plurality of optical fiber holding holes that penetrate from the introduction port to the one end surface and hold each of the plurality of optical fibers;
a window hole that penetrates from the front surface to the introduction port; and
a gate mark that is formed at the time of injection molding,
wherein the gate mark is formed on the pair of side surfaces which are located on the other end surface side with respect to the window hole in the first direction, and
wherein a distance between a center of the gate mark and the front surface in the third direction is less than a distance between the center of the gate mark and the back surface in the third direction.

11. The optical connector ferrule according to claim 10, wherein an opening width of the window hole in the second direction on the front surface is in a range of 60% to 90% of a gap between the pair of side surfaces in the second direction,

12. The optical connector ferrule according to claim 10, wherein an opening width of the window hole in the second direction on the front surface is in a range of 3.9 mm to 6.2 mm, and
wherein a distance between a center position of the gate mark and a plane which is separated by an equal distance from the front surface and the back surface in the third direction is in a range of 0.1 mm to 1.25 mm.

13. The optical connector ferrule according to claim 10, wherein at least one optical fiber holding hole array including 16 or more optical fiber holding holes which are arranged in the second direction is arranged in the third direction.

14. The optical connector ferrule according to claim 10, wherein a size of the gate mark in the first direction is in a range of 0.5 mm to 1.2 mm and a size of the gate mark in the third direction is in a range of 0.5 mm to 2.5 mm.

15. The optical connector ferrule according to claim 10, wherein the resin is a polyphenylene sulfide resin.

16. The optical connector ferrule according to 10, wherein an angle which is formed by a center axis of the plurality of optical fiber holding holes and a normal line of the one end surface is in a range of 10° to 20°.

17. The optical connector ferrule according to claim 10, wherein an angle which is formed by a center axis of the plurality of optical fiber holding holes and a normal line of the one end surface is 8°.

18. The optical connector ferrule according to claim 10, wherein an angle which is formed by a center axis of the plurality of optical fiber holding holes and a normal line of the one end surface is 0°.

19. An optical fiber with a connector, comprising:
the optical connector ferrule according to claim 10; and
a plurality of optical fibers that are introduced from the introduction port and are held in the plurality of optical fiber holding holes, front end faces thereof being exposed from the one end surface.
